(19) United States
(12) Patent Application Publication
(10) Pub. No.: US 2013/0275435 A1
(43) Pub. Date: Oct. 17, 2013

(54) CODE BASED INDEXING AND INFORMATION RETRIEVAL SYSTEM

(71) Applicants: Kwei Wing CHAN, Hong Kong (HK); Ho Fung Tsui, Hong Kong (HK)

(72) Inventors: Kwei Wing CHAN, Hong Kong (HK); Ho Fung Tsui, Hong Kong (HK)

(73) Assignee: Kwei Wing Chan

(21) Appl. No.: 13/445,949

(22) Filed: Apr. 13, 2012

(51) Int. Cl. G06F 17/30

(52) U.S. Cl. CPC G06F 17/30321
USPC 707/741

(57) ABSTRACT

An indexing and information retrieval system includes a database configured for storing a record of content and indexing the record with a code and property of predetermined location information, a member device configured for inputting the record to the database with the code and the corresponding property of predetermined location information, and a client device configured for retrieving the records from the database with the code. The code is associated with a predetermined location.

### FIELD OF THE PATENT APPLICATION

The present patent application generally relates to digital data indexing and retrieval technologies and more specifically to an indexing and information retrieval system utilizing location information that allows a searcher to directly retrieve target information by dialing a short code.

### BACKGROUND

The performance of the internet search engines highly relies on the design of index, including factors such as merge factors, storage techniques, index size, and fault tolerance. All factors bring out the importance on indexing technique. Various kinds of search engines bring out a long and detailed result list, which lead to another problem, time cost for the searchers to recurrently hit for looking up the content on each result link. This try by luck pattern does not shorten the searching time but increase the fault rate. The problem will be even worse when searcher faces ambiguity on multilingual indexer and multiple file formats, especially from human mistakes on a faulty document in wrong index tables.

Advertisers and publishers who rely on the capability of the search engine will place high cost but low rate on opportunity to see (OTS). Extra cost need to be added on banner ads to attract the public awareness. Search engines gradually create a growing pool of search results and make information retrieval increasingly difficult.

### SUMMARY

The present patent application is directed to an indexing and information retrieval system. In one aspect, the indexing and information retrieval system includes a database configured for storing a record of content and indexing the record with a code, a member device configured for inputting the record to the database with the code, and a client device configured for retrieving the record from the database with the code. The code is associated with a predetermined location.

The location may be an area that includes a circular area having a radius about a specified geographic reference point. The location may be an area defined by at least three geographic reference points. The area defined by at least three geographic reference points may be a polygon.

The member device may be configured to input the record with the code and information regarding a property of the predetermined location. The client device may be configured to retrieve the record by inputting the code and the information regarding the property. The database may be configured to index the record with the code and the location information regarding the property. The property of the predetermined location may include an identification code. The identification code may be an International Direct Dialing code (IDD), an IP address, a postal code, a zip code, a global location number (GLN) and even precisely the latitude and longitude data, and etc.

The member device may be configured to input the record with the code, information regarding a property of the predetermined location, and a category of the record. The client device may be configured to retrieve the record with the code, the information regarding the property of the predetermined location and the category of the record. The database may be configured to index the record with the code and the information regarding the property of the predetermined location and the category of the record.

The member device and the client device may be computers connected to a network, and the database may be implemented on a server connected to the network.

The location information may be the information regarding the current location of the client device. The database may be configured to give a higher ranking to the record with location that is closer to the current location of the client device.

The location information may be the information regarding the locations that the client device has been to recently and the database is configured to give a higher ranking to the record witch location that the client device has recently been to more frequently.

The location information of the client device may be generated through a Global Positioning System or a computer network. The client device may be configured to send location information of the client device to the database by sending information regarding a nearby location.

The code may be a numerical code, and the client device may be configured to input the code by the client who percepts the code from a publication or an advertisement by visualization, hearing or touching, and inputting the code to the indexing and information retrieval system by a keyboard, a flat monitor, a camera, a microphone, or a scanner etc. The record of content may include the inputted detailed information by the Acode member, a geographic map or be linked to a web site.

The code may be a numerical code associated with a predetermined location. The member device is configured to input the record with the code and information regarding a property of the location information. The client device is configured to retrieve the record with the code and regarding the property of location information. The database is configured to index the record with the code and the property of location information.

The code may be associated with a plurality of locations that include the predetermined location. The database may be configured to determine a ranking associated with the plurality of locations. The ranking method is based on the rule of “SHORT DISTANCE FIRST LISTED” (SDFL). The client device may be configured to send its property of location information to the database and retrieve the record with the code and the ranking.

In another aspect, the present patent application provides a method for code based indexing and information retrieval. The method includes storing a record of content and indexing the record with a code and the property of location information by a database, inputting the record to the database with the code by a member device, and retrieving the record from the database with the code and the property of location information by a client device.

### BRIEF DESCRIPTIONS OF THE DRAWINGS

FIG. 1 shows a high level overview of an information retrieving system (also referred to as the Acode System) according to an embodiment of the present patent application.

FIG. 2 illustrates an example poster of a tangible media object.

FIG. 3 illustrates the formation of an Acode as a label printed on a tangible media object.

FIG. 4 is a flow chart illustrating a registration operation of the Acode System of FIG. 1 by Acode members.

FIG. 5 is a flow chart illustrating an access process of the Acode system of FIG. 1 by mobile user through a member device.

FIG. 6 illustrates the Acode system of FIG. 1 being applied to different cities in the world.

FIG. 7A illustrates some steps of the operation of a mobile interface of the Acode system of FIG. 1.

FIG. 7B illustrates some other steps of the operation of a mobile interface of the Acode system of FIG. 1.

FIG. 8 illustrates the generation of a ranking table of the Acode system of FIG. 1.

FIG. 9 is a virtual routing record generated by the Acode system of FIG. 1.

FIG. 10A illustrates a part of client interfaces of an inner building-wise implementation of the Acode system of FIG. 1.

FIG. 10B illustrates another part of client interfaces of the inner building-wise implementation of the Acode system of FIG. 1.

### DETAILED DESCRIPTION

Reference will now be made in detail to a preferred embodiment of the code based indexing and information retrieval system (referred as Acode System hereafter) disclosed in the present patent application, examples of which are also provided in the following description. Exemplary embodiments of the code based Acode system disclosed in the present patent application are described in detail, although it will be apparent to those skilled in the relevant art that some features that are not particularly important to an understanding of the code based Acode system may not be shown for the sake of clarity.

Furthermore, it should be understood that the code based Acode system disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

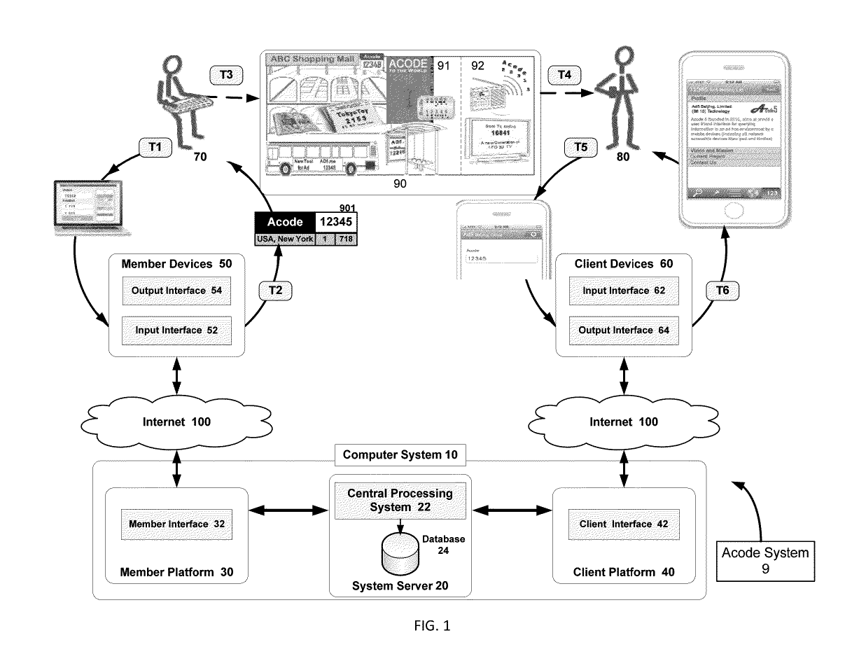

FIG. 1 shows a high level overview of an Acode system according to an embodiment of the present patent application. Referring to FIG. 1, the Acode system 9 includes a networked computer system 10, which includes a member platform 30, a system server 20 and a client platform 40. The Acode System 9 also includes a plurality of member devices 50 and client devices 60. The member devices 50 and client devices 60 are connected to the computer system 10 through the internet 100.

The system server 20 includes a central processing system 22 and a database 24. The central processing system 22 is a software system that runs on the system server 20, which executes the member platform 30 and the client platform 40. It collects inputs, processes data and serves outputs between these two platforms. The central processing system 22 also accesses the database 24 and provides the business logic controls of the computer system 10. The database 24 is configured for storing, filtering and grouping of records, wherein each record is processed with at least an Acode, the properties of predetermined locations (also referred to as location information hereafter) and the content.

The location can be a point, a line or an area defined by a set of geographic coordinates.

Location information may include information which defines the corresponding location. It may be specifying one or more countries, one or more (inter-country) regions, one or more states, one or more metro areas, one or more cities, one or more towns, one or more boroughs, one or more areas with common zip codes, one or more areas served by common cable head end stations, one more or areas served by common network access points or nodes, one or more geographic areas defined by some other means, and etc.

Location information may also include latitude and/or longitude, or a range thereof. Thus, for example, the location may be or include an area defined by a geographic reference point and perhaps some additional information, such as a circular area of a defined radius about a point defined by latitude and longitude coordinates for instance.

As another example, the location may be an area defined by three or more geographic reference pints, such as a triangle, rectangle, pentagon or some other polygon defined by a number of geographic reference points.

The location information may include information such as an IP address, from which a user location can be estimated.

The member platform 30, having a member interface 32, is a software system for members to manipulate Acode records. The member interface 32 is a software interface for the member devices 50 to connect. It can be a web server, a web service or any kind of application programming interfaces (APIs). The member devices 50 exchange data with the member interface 32 through the Internet 100.

The client platform 40, having a client interface 42, is a software system for clients to access Acode records. The client interface 42 is a software interface for the client devices 60 to connect. It can be a web server, a web service or any kind of APIs. The client devices 60 exchanges data with the client interface 42 through the Internet 100.

The member device 50 is a networked computing device, including input devices 52 and output devices 54, which are used by the Acode member 70 to access the member interface 32 through the Internet 100. The input devices 52 can be a keyboard, a keypad, a mouse pointer, a ball track mouse, a touch panel, a camera, a scanner, an image receiver, a microphone, an audio receiver, and etc. The output devices 54 can be a monitor, a computer displaying unit, an image producer, a projector, a speaker, an audio producer and etc.

The client device 60 is a networked computing device, including input devices 62 and output devices 64, which are used by the Acode client 80 to access the client interface 42 through the Internet 100. The input devices 62 can be a keyboard, a keypad, a mouse pointer, a ball track mouse, a touch panel, a camera, a scanner, an image receiver, a microphone, an audio receiver and etc. The output devices 64 can be a monitor, a computer displaying unit, an image producer, a projector, a speaker, an audio producer and etc.

Marketing channels 90 includes the possible publishing methods used by the Acode member 70 who associates Acode together with the advertising materials in both tangible and non-tangible forms. The tangible media objects 91 can be advertisements on newspaper, magazine, bus-stop poster and etc. The non-tangible media objects 92 can be advertisements on radio announcement, TV ads and etc. An Acode client 80 therefore can recognize and memorize the Acode easily and input the Acode into his client device 60.

As shown in FIG. 1, a detailed information flow of an exemplary system for Acode system 9 is presented. In FIG. 1, “Tx” represents a time sequence of steps or events that take place, with T1 being the earliest step while T6 being the last step.

At T1, an Acode member 70 collects or writes detailed information of a publication or an advertisement including its targeted location information and enters such information into a member platform 30 of a networked computer system 10 through the Internet. After that, an Acode will be decided, either selected by the Acode member 70 or generated by the computer system 10. The computer system 10 will apply the targeted location information and the Acode as indexers. A central processing system 22 will process the communication between the member platform 30 and the database 24. If the Acode member 70 initially communicates with the computer system 10, he needs to register a membership account and pay for the Acode system service.

At T2, the computer system 10 replies a registered Acode to the member device 50 and displays it on the output interface 54. The registered Acode can be displayed in a form of Acode label 901.

At T3, the Acode member 70 will announce or publish the assigned Acode 901 with the publication or advertisement by at least one marketing channel 90. The publications or advertisements can be announced or published along with a yard sign, billboard, magazine, newspaper, poster, vehicle banner, print ad, signpost, banner on a building, a shopping mall, a Braille tag or reader, radio ad, or any type consumer oriented advertisement. Such publication or advertisement will be announced or published at the corresponding locations of the assigned Acode 901.

At T4, an Acode client 80 (an interested party) perceives the publication or advertisement. If he is interested in the content, he can mark down or memorize the Acode 901.

At T5, the Acode client 80 sends an Acode request to the Acode system 9 by inputting the Acode 901 into the Acode website or application by his client device 60. The client device will send its properties of location information to the computer system 10 through the Internet. A client platform 40 is responsible to pass the Acode and the properties of location information to the central processing system 22 which processes and compares the Acode and the properties of location information against the system database 24. The central processing system 22 will provide the filtered and ranked result list to the client interface 42, after which the Acode client can preview the detailed record in the output interface 64 of his client device 60.

At T6, the computer system 10 returns a list of records associated with the requested Acode. The list of records is ranked by the shortest distance from the client's location.

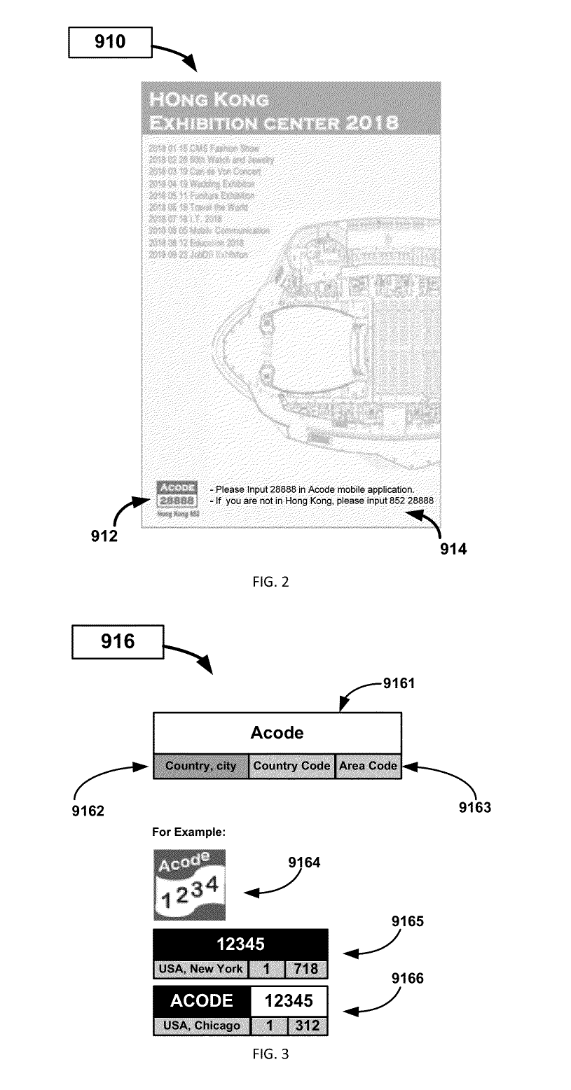

FIG. 2 illustrates an example poster of a tangible media object 910. Marketing material in Acode system 9 of FIG. 1 includes tangible objects 91 and non-tangible objects 92. In FIG. 2, the tangible media object 910 includes an Acode label 912 and an Acode instruction 914 as shown in the text. If an Acode client is interested in the content of the tangible media object, he can easily memorize and dial the Acode by his mobile in order to retrieve the detailed information without any need to write down a note or take a photo of the object.

FIG. 3 illustrates the formation of an Acode label 916 printed on a tangible media object. Referring to FIG. 3, the Acode includes three elements: (1) a decimal number 9161; (2) the location information in terms of country and area in text 9162; and (3) the country and area code in terms of IDD code 9163. The Acode label design is flexible while the color and the layout are subjected to the article. Three examples are shown in FIG. 3: (1) a decimal number with “Acode” 9164; (2) a decimal number with location information 9615; and (3) a decimal number with location information and “Acode” 9616.

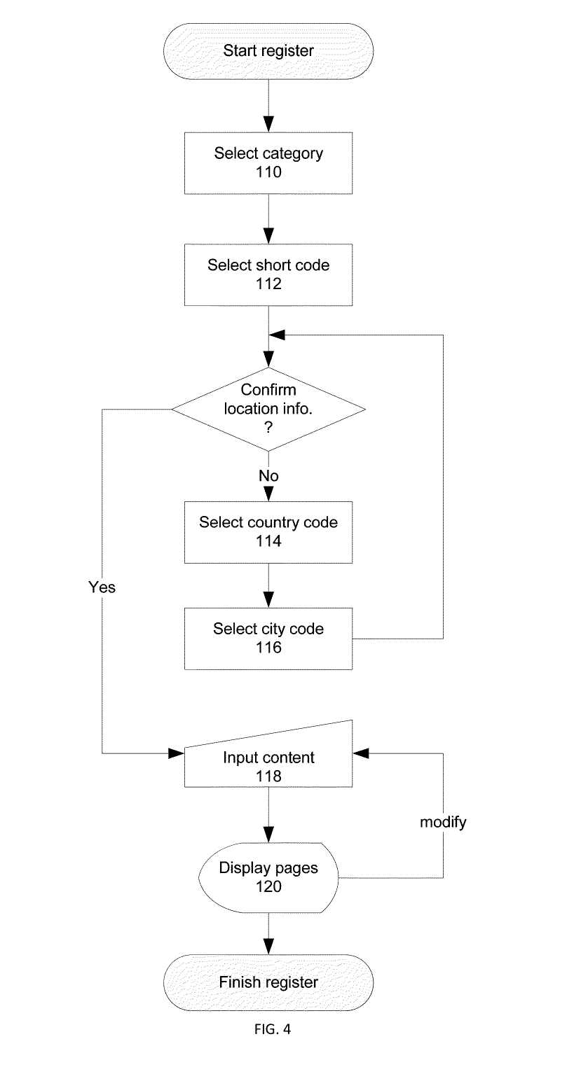

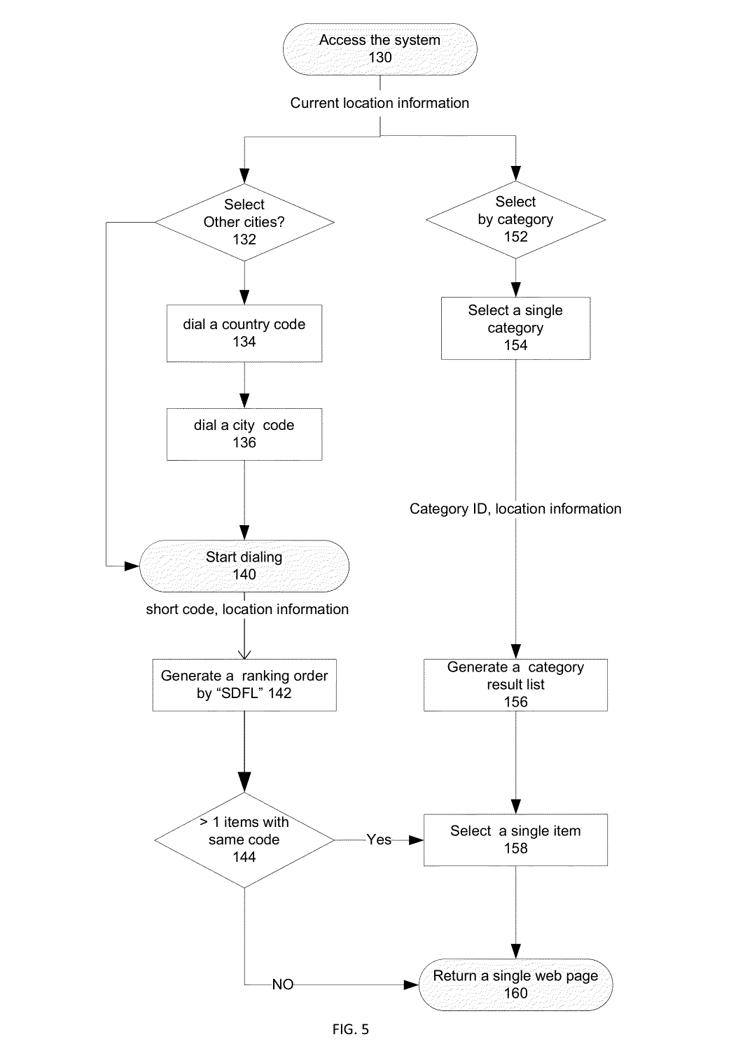

FIG. 4 is a flow chart illustrating a registration operation of the Acode system that is the Acode System 9 of FIG. 1 by Acode members. The Acode system includes two types of users: the “Acode members” who register a particular type of codes (referred to as “Acode” hereafter) and the public mobile users named “Acode clients” who retrieve information with the Acode by their client devices 60 of FIG. 1, such as smart phones, tablets, personal computers, notebooks, netbooks, tablet devices etc. The Acode members mainly come from business units such as commercial companies and advertising agencies who apply or have channels to announce the Acode to the public. For example, a member can publish an Acode label at the corner of a printed ad in a newspaper or magazine

Referring to FIG. 4, an Acode member needs to identify his business type 110 before selecting an Acode 112. Meanwhile, the member has to provide the location information of the publication or advertisement. In this embodiment, the location information is defined by IDD codes which include country code 114 and city code 116. Alternatively, the location information can also be city names, IP addresses, postal codes, zip codes, global location numbers (GLN), latitude and longitude data, and etc.

In the step 118, the Acode member can manually input his company profile as well as publication or advertisement content through a web form provided by the member interface 32 at FIG. 1.

For those Acode members who already have their web sites, the Acode system has another option for them to link a registered Acode with the URL address of their existing web site. The output devices are equipped with simulators for the members to evaluate the appearance of the publication or advertisement.

In step 120, the Acode system allows the member to preview the content in his member devices at the output interface 54 as shown in FIG. 1. The output devices are various kinds of simulators built in at the web page or APIs. The output interfaces 54 of FIG. 1 also allow the member to set an announcement schedule of the publication or advertisement.

FIG. 5 is a flow chart illustrating a process of how an Acode client accesses the Acode system 9 of FIG. 1. The Acode system will retrieve the client device's property of location information and display such location information in the client device.

In one embodiment, an Acode client who is interested in a publication or advertisement can recognize the Acode and access the Acode system 130 by his client device to retrieve detailed information through a website or application. After that, the Acode client can select the location of the Acode he wants to access. Since his current location has already been detected by the client device using its property of location information, therefore, he can select his current location, or he can select another location by dialing an IDD code in terms of country and city codes.

In another embodiment, an Acode client locates in Shinjuku, Tokyo, tries to access the Acode system by his client device. The property of location information reveals he is in Shinjuku, Tokyo, which will be displayed in the client device; he can select Shinjuku, Tokyo directly for the Acode access. After that, he can input an Acode ‘12152’ to retrieve the relevant information. The Acode system will return a localized result list 142 for records located at Tokyo area only. If the list has more than one item, it means more than one Acode member in Tokyo are using the Acode ‘12152’. Therefore, the Acode system will calculate the distances between the location of the client device and the locations of the publications or advertisements which have the same Acode ‘12152’. The result will be listed in the order of the shortest to the longest distance, and the rule is called “SHORT DISTANCE FIRST LISTED” (SDFL). In this embodiment, an Acode registered for Shinjuku will be ranked with higher priority than one registered for Chiyoda which is further away than the client's location. Finally the Acode client selects a single item 158 and accesses the corresponding web page 160.

In another embodiment, an Acode client can retrieve detailed information of an Acode from a city other than his current location. He can dial a country code and then a city code by means of IDD (International Direct Dialing) prefix in the steps 132 and 134. In this embodiment, if his current location is in Tokyo and he dials IDD city code 852, he will get a result list from Hong Kong instead of Tokyo.

In another embodiment, an Acode client can select by category 152 instead of dialing an Acode. After that, he can select a single category 154. The category and property of location information will be sent to the computer system, after which a result list of that category 156 ranked by the rule of SDFL will be generated. Finally, a web page 160 of the selected item 158 from the result list will be displayed.

The Acode system binds Acode with location information as an indexer. The location information includes city names, geolocations by IDD codes, IP addresses, postal codes, zip codes, global location numbers (GLN) and even precisely the latitude and longitude data, and etc. Therefore, the Acode system can be applied in different scales of geographical areas. During the implementation, three types of scale are considered as below:
a. Intercity-wise implementation: Allow a single short code to serve different cities across the national boundaries.
b. Intracity-wise implementation: Keep track and compare the physical distance from searcher's device to the short code physical location within a single city.
c. Inner Building-wise implementation: Retrieve information based on the searcher.

a. Intercity-Wise Implementation

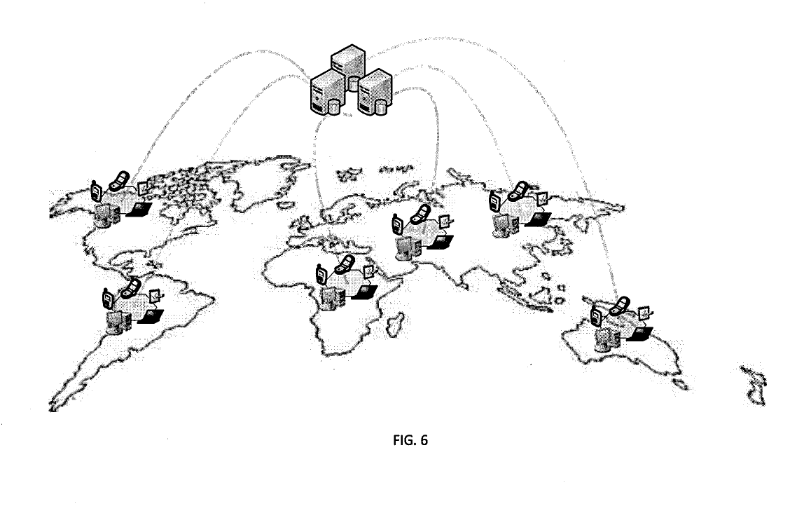

FIG. 6 illustrates the Acode system 9 of FIG. 1, which is being applied to different cities in the world. In this embodiment, an Acode of 5 digits is taken into account. Each Acode member can apply more than one Acode, and each Acode can also be applied by different members at different locations. Therefore, even with an Acode as simple as “12345”, the Acode system can serve numerous accounts at all cities in the world as illustrated in FIG. 6.

When an Acode client accesses the Acode system through a mobile application, his location information through IP address, GPS record and cookies data will be provided to the Acode system. Therefore, when he dials an Acode “12345”, the Acode system will utilize his location information and return a result list of businesses for that Acode “12345” located in the same city or town as where he is. The Acode client can bookmark the Acode for further use or return to the front page and continue his searching process either by selecting another city through the well-known IDD prefix or browsing the category list.

In the Acode system, each Acode member who registers an Acode needs to identify which cities the Acode will be applied for and what kind of business it belongs to. This requirement optimizes the reusability of the codes among different cities.

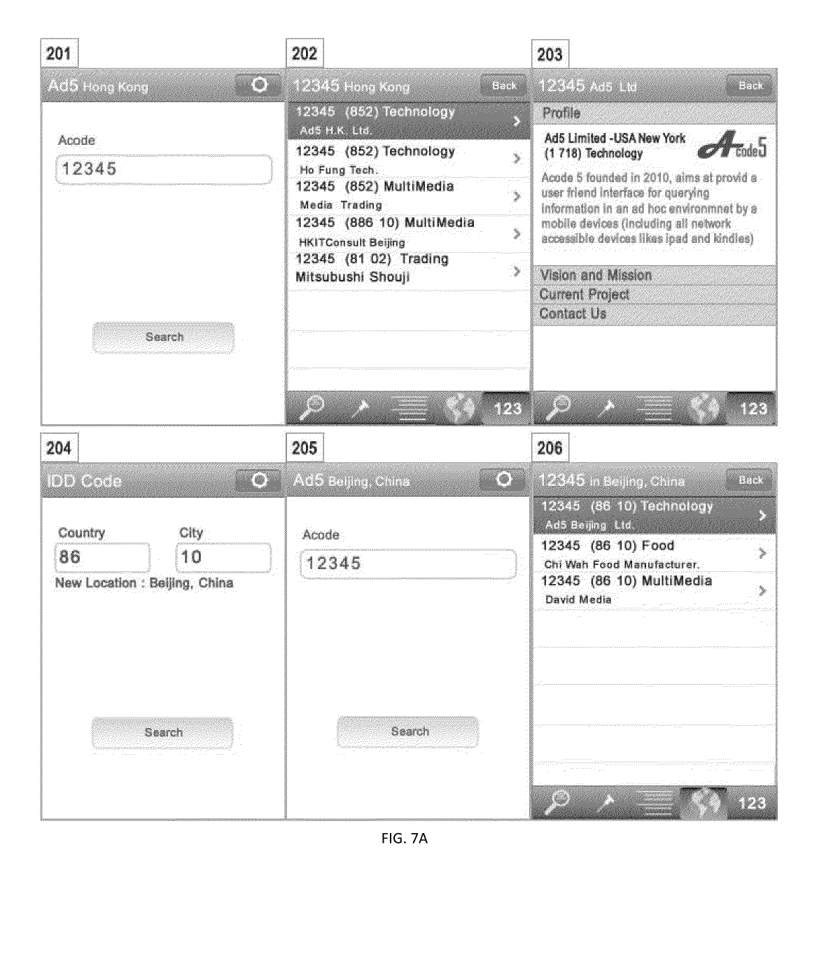

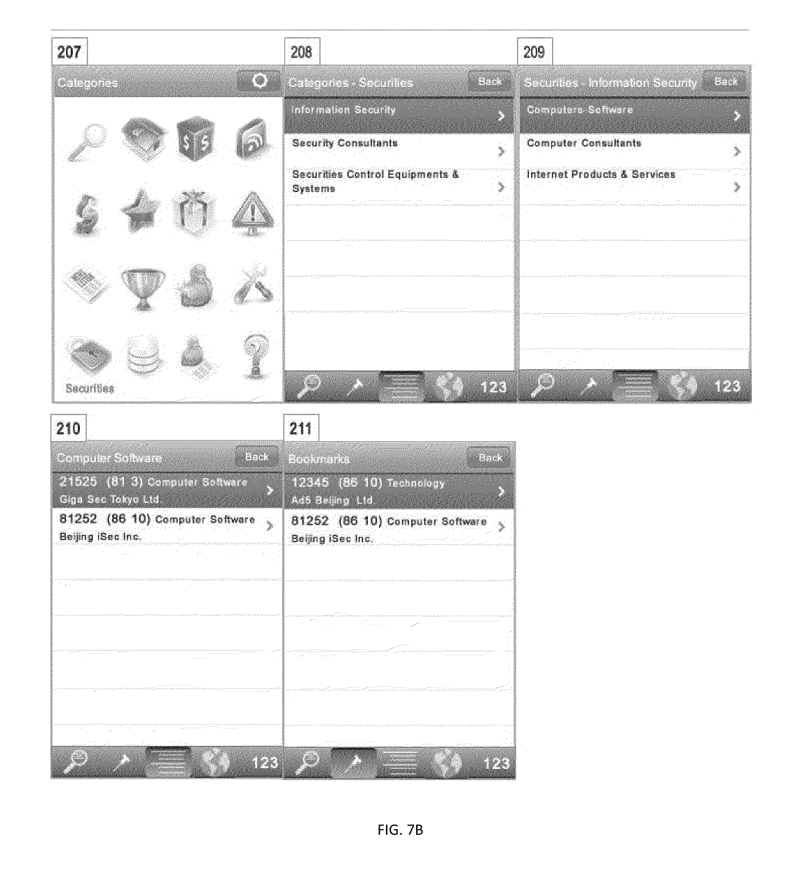

FIGS. 7A-7B illustrate steps of the operation of an output interface 64 of FIG. 1, which includes the following steps:

Step 201: An Acode client, who perceives an Acode from a publication or advertisement, can access the Acode system either by dialing an Acode in his client devices through the website or applications. The Acode system will automatically show his location information in the title of the output interface. His location information, for example ‘Hong Kong’ is determined by the properties of location information such as IDD codes, IP addresses, GPS records, cookies, and etc.

Step 202: The Acode system will provide a ranked result list for the Acode “12345” in Hong Kong by means of ‘SDFL’. For example, the item with IDD code (852) represents the record is associated to Hong Kong, The Acode client can select an item so as to display the detailed information in his client device.

Step 203: The client device displays the detailed information of the selected item. The Acode and the company name “12345 Ad5 H.K. Ltd” are shown in the title of the output interface. The content is classified into different sections such as “Profile”, “Vision and Mission” “Current Projects”, “Contact Us”. All these sections can be amended by the Acode member. Therefore the display pattern of one member may be different from that of another member.

Step 204: The Acode client can also dial an Acode with IDD prefix to access information from other cities. The IDD codes are well-known and can be readily used by the client. The IDD codes are also printed as Acode label 9163 of FIG. 3. For example, the Acode client dial 86 10 at the page of IDD code, the system will automatically show the location as Beijing, China below the text field in the output interface.

Step 205: The Acode client can continue to dial a 5 digit Acode which is published as an Acode label in the magazine.

Step 206: A result list of the Acode “12345” are shown with the city name as Beijing, China in the title. Again, each item will show the Acode, IDD code (86 10), the business type and the company name. The Acode client can select any item and view its detailed information as shown in the step 203.

Step 207: Referring to FIG. 7B, the Acode system also accommodates the human habit on browsing information by category lists. In this embodiment, the Acode system has designed category list in three levels. In this step, a number of categories are designed as icons.

Step 208: Once the Acode client selects an icon “Securities” in the step 207, a second level of categories are listed in next page. The Acode client can continue to select the category “Information Security”.

Step 209: The Acode system will display the last level of categories listed in a navigation list format under “Information Security”. The client can select a record from the third level of categories such as “Computer Software”.

Step 210: All companies under “Computer Software” are listed in this item page. Each item shows the Acode, the IDD code, the category name and the company name. The Acode client can select any item to retrieve detailed information accordingly.

Step 211: The Acode system also allows an Acode client to bookmark his interested Acode in his client devices.

In this embodiment, if, for example, an Acode ‘12152’ has been shared by more than one business unit, i.e. “Acode member”, for a particular city, the result list will be filtered by Acode for that city only. If the length of the Acode is limited to 5 or 6 digits, there are maximum 99999 to 999999 combinations of Acode available in a single city. The extensibility of the Acode system is decided by the number of cities using the system, and the combinations can be unlimited.

b. Intracity-Wise Implementation

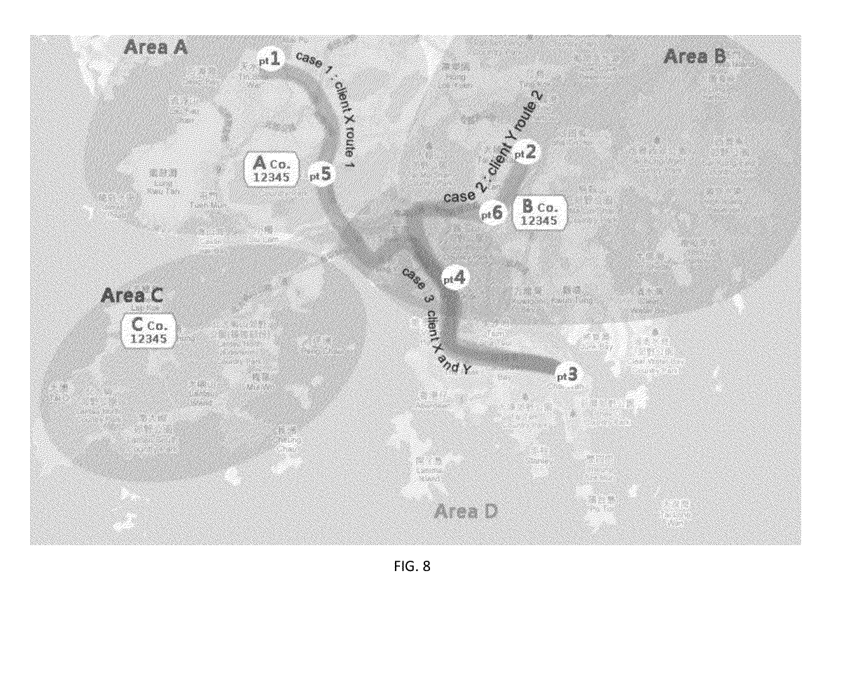

Referring to FIG. 8, the design is mostly announced in a printed ad located in a fixed position. For example, a tangible media object can be a poster printed on a wall of a building or a bus-stop poster, which is eye-catching with the Acode label printed on it. The Acode system can use an Acode in a length of 4-5 digits which can be easily and quickly memorized by the human brain. Even when an Acode client passes by the ad in a moving vehicle, he can easily memorize and dial the code by his mobile device.

The Acode system applies a ranking table to handle collisions among different records of a single Acode within a city. The Acode system will compare the distances among the Acode client and those posted publication or advertisement in order to get the ranked result list in order of ‘SDFL’. For example, in an embodiment, an Acode “12345” is being used to serve three different members (Company A, Company B and Company C) in Hong Kong as shown in FIG. 8. Table 1 illustrates the generation of a ranking table of the Acode system.

Three cases are illustrated in FIG. 8. Referring to FIG. 8, in case 1, starting in Area A, a client X is travelling from Area A point (pt) 1 to Area D pt 3 via Route 1. In the middle of his journey, he is attracted by a wall poster from company A and memorizes an Acode “12345” at pt 5 in Area A. When he dials the Acode with his mobile device, he has actually provided his real time location information to the Acode system through the Internet. The Acode system will detect the geographical location from client X's mobile device by means of properties of location information such as IDD codes, IP addresses, postal codes, zip codes, global location numbers (GLN) and even precisely the latitude and longitude data, and etc. The location can be identified either by a reference point or a reference area. Consequently, the Acode system will compare the location information with each Ad under the code of “12345”. A ranking table as shown in Table 1, will then be generated and a result list will be sent to the client X's mobile device. The closer is the ad location to the client, the higher the ranking of the ad will be in the result list.

TABLE 1

| Client X' s location | |
|---|---|
| Location for all | |
| Acode = “12345” | Location & Ranking |

| Reference Point | Area | Company | Km | Ranking |
|---|---|---|---|---|
| Pt 5 | A | A Co. Ads | 0 | 1 ✓ |
| | B | B Co. Ads | 2 | 2 |
| | C | C Co. Ads | 9 | 3 |

From TABLE 1, a higher ranking will be given to company A at location pt 5 in Area A. Although company B and C are using the same Acode “12345”, comparing to the company A, they are computed to be located in other areas that are further away from the client X.

In case 2, in Area B, a client Y is attracted by another ads from Company B and the eye catching Acode “12345” at pt 6 of Area B. When he dials the Acode “12345”, the Acode system will create another ranking table similar to the above-mentioned case 1. In Area B. there is only Company B who has placed the ad along route 2. Therefore, it gains the highest rank and is displayed as the top item in his mobile device.

In case 3, referring to the client X and Y mentioned above, if both of them do not dial the Acode until they arrive at pt 4, a reference point where Area A and Area B are overlapping. When the Acode system starts to generate the ranking table for comparison, it also takes into account the client's location history. The Acode system will base on the client's previous locations retrieved from points to line form through three main sources:

1. GPS record: depending on the devices that have the GPS locations stored
2. History in Acode system: previous accessed reference points from the client
3. Cookies or application: locations that the client usually stayed. For example, client X usually appears in Areas A and D.

TABLE 2

Location for short code = “12345”

| Time | Clients | Area | Reference Pt | Company |
|---|---|---|---|---|
| −2t | X | A ✓□ | | |
| −1t | X | A ✓□ | | |
| 0t | X | A ✓□ | Pt 4 | A Co. Ads ✓ |
| | | B | | B Co. Ads |
| −2t | Y | B ✓□ | | |
| −1t | Y | B ✓□ | | |
| 0t | Y | A | Pt 4 | A Co. Ads |
| | | B ✓□ | | B Co. Ads □✓ |

Referring to TABLE 2, in the past −2t time period, the client X has appeared in Area A more frequently while the client Y has appeared in Area B more frequently. Therefore, Area A gets a higher ranking for the client X and Area B gets a higher ranking for the client Y. As a result, the A company's ads are chosen for the client X and the B company's ads are chosen for the client Y.

c Inner Building-Wise Implementation

The Acode system can also supplement the problem of the lack of or weak in GPS signals inside a building. The system can display an ad hoc electric road map in the mobile device; to help client identify his current location in the public area like shopping mall, exhibition center or car park.

A client can dial an Acode to download a floor plan for a particular building, such as shopping mall. The Acode system will receive the Acode client current location and compare the distance and direction from the client's current location to the shopping mall. If the Acode client is outside of the shopping mall, the Acode system will display a floor plan and provide an electric signage board in the client device accordingly. If the Acode client is inside the shopping mall, the Acode system will directly upload the floor plan to the client device, and require the client to confirm which floor he is located at.

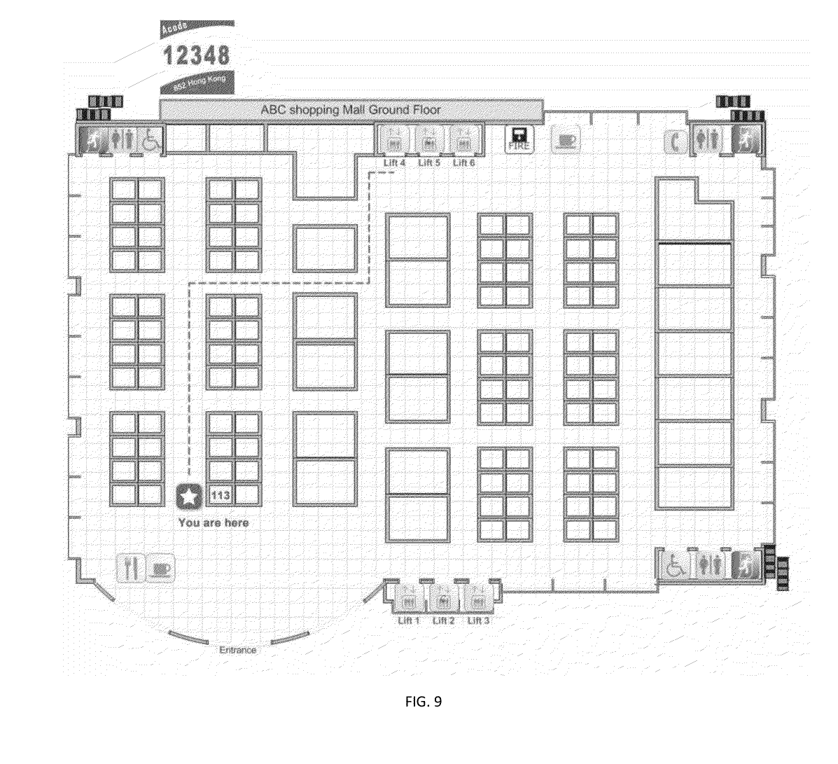

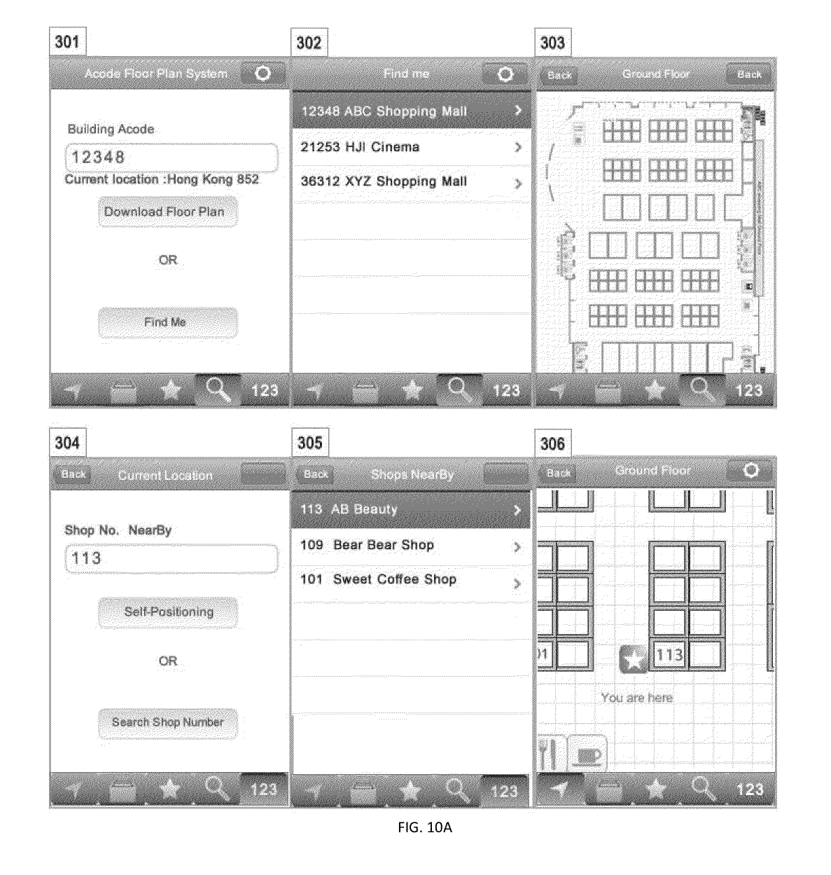

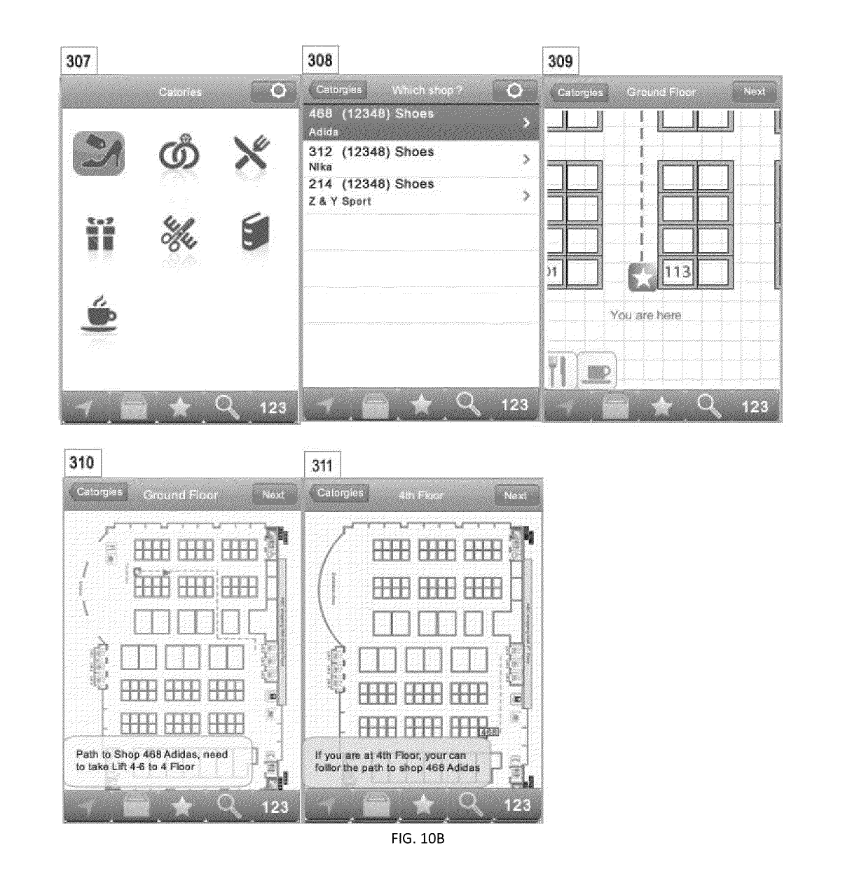

FIG. 9 is a virtual routing record generated by the Acode system to an Acode client Z who walks into a shopping mall with Acode “12348”. FIGS. 10A-10B illustrate the ground floor's floor plan of the shopping mall and a path that the Acode client needs to walk through. Once the Acode client marks his first reference point according to a shop number label printed on the wall 113 nearby, the Acode system will mark the data as the client's starting reference point. Then, a part of the floor plan will be displayed on the client's device. This design allows the client to self-position himself without any needs to concern the strength of GPS signal. Property management unit can also enjoy zero cost to implement this invention, without investing an extra equipment infrastructure.

FIGS. 10A-10B illustrate client interfaces of an inner building-wise implementation of the Acode system of FIG. 1. Referring to FIG. 10, an Acode client Z visits an ABC shopping mall, for which the Acode is “12348”. The operation of the floor plan interface includes the following steps:

Step 301: A client Z wants to go to a shoe shop (“Adidas”) in ABC shopping mall, therefore he inputs the building's Acode “12348” in his client device to download the detailed information as well as the updated floor plan for the shopping mall.

Step 302: Alternatively, the client Z does not know the Acode of the mall, he can press “Find Me” to get a result list of all the buildings nearby.

Step 303: Acode system returns a floor plan at the ground floor of the ABC shopping mall and display in the client device.

Step 304: The client Z may get lost when he walks in the mall; therefore he has to input a shop number from a shop nearby himself, for example 113. The client Z can also press “Search Shop Number” to receive a result list for all shops nearby.

Step 305: A result list for shops near the client Z are generated in the client device. Client Z can select any one of the shops which can represent his current location.

Step 306: A marker of “You are here” is shown in the ground floor's floor plan in the client device, where is the location next to shop 113.

Step 307: Referring to FIG. 10B, client Z can search the destination shop through a category list of the ABC shopping mall

Step 308: When the client Z chooses the category of “shoes”, a result list of shoe shops with the corresponding shop numbers and shop names are generated in the client device. In this example, client Z chooses a shop “Adidas”.

Step 309: The Acode system will compare and show a shortest path directing to “Adidas” from the client Z's current location.

Step 310: A full screen floor plan is shown in the client device, which is started from the ground floor of ABC shopping mall and associated with the shortest path to visit the shop “468” at the 4^{th} floor. In this example, the current location of the client Z is at the ground floor where is near the shop 113, the system therefore directs client Z to walk towards the lift and take the lift to the destination at the 4th floor. The client Z can press “next” to get a full screen of the ground floor to understand the direction and the distance to the lift 4-6. A pop up message gives the client Z an instruction on the direction.

Step 311: When the client Z follows the message to take the lift to 4th floor, he can continue to press the “next” button to get another hint and a path towards the destination “shop 468”.

In TABLE 3, a location table can be used to describe the movement of client Z step by step from the start point “shop 113” to the destination “shop 468”.

TABLE 3

| | Building | | n^{th} Floor | Shop |
|---|---|---|---|---|
| Client | Acode | Date Time | (z) | Number |
| Z | 12348 | 20101011 15:23:11 | 1 | 113 |
| | | 20101011 15:23:34 | 1 | Lift 4-6 |
| | | 20101011 15:23:58 | 4 | Lift 4-6 |
| | | 20101011 15:24:30 | 4 | 468 |

With regard to the availability of receiving the Acode number in virtual environment, according to the above embodiment, the availability of visibility of an Acode includes publishing the Acode on printed materials or electronics devices such as TV or LCD display board, so that the Acode clients can read and memorize it. The availability of hearing of an Acode includes spelling the Acode through broadcasting system like radio, so that the clients can listen and memorize it. The availability of touching of an Acode includes displaying the Acode by using Braille alphabet such that blind persons can read and memorize it.

With regard to the inputting method of Acode system, according to the above embodiments, the client may input an Acode through a number keypad with physical buttons or a number keypad simulator displayed on a flat screen. The Acode client may input an Acode through an audio receiver, including a microphone equipped with a personal computer, a portable tablet, a Smartphone, a mobile phone, or etc. The spelling of the Acode is recorded by the client device as a voice file and recognized by the client device or the server side computer system and converted to a computer recognized decimal number. The Acode client can also input an Acode through scanning the Acode label printed on a tangible material such as posters or magazines.

With regard to the application on marketing aspect by further analyzing the Acode system, in the above embodiments, the Acode system may be used for generating marketing analysis to the Acode member, which is based on the characteristic of using different non-unique Acode pointing to a single record and publishing the Acode in different marketing channel. For example, an Acode “12344” can be assigned for newspaper while an Acode “12346” for TV ads. A hit rate report shows the number of potential clients who have taken action to access the Acode content can reflect the success of that publishing channel, which can be the prove to continue investing the marketing resources on that channel. A hit rate report shows the success of a marketing channel in a particular area. The hit rate report can also show the real time customer reactions to any special campaign such as sales promotion within a specified time period. A demographic report can also show the different potential customer clusters distributed among cities or countries.

In the above embodiments, the commercial value of the Acode system mainly depends on its capability to break the boundary between the Internet and traditional media materials and helps a publisher, commercial party or the Acode member substantially extend their market channels to all kinds of internet accessible devices, such as smart phones, tablets, personal computers, notebooks, netbooks, tablet devices etc. Therefore, the publication or advertisement can be broadcasted in region independent and time independent bases.

The benefits of the embodiments of the present patent application are the most significant in the advertisement industry. The information shown on the advertisement of TV, newspaper, magazine, poster or banner is all one way, only generating a reception to the audience. On one hand, the embodiments give a path to the interested audiences to retrieve more information immediately before they forget about the advertisement. On the other hand, the one way reception becomes a two way communication. The audience can leave feedbacks through the Internet while the advertiser can track the number of users who have accessed the Acode system to evaluate the efficiency of that advertisement. Particularly, the hit rate through the Acode system comes from the target audiences who take the initiative to read the Acode record, which are the potential customers for the advertiser.

The marketability of the Acode system comes from its reusability of Acodes by using the location information, and the flexibility in classifying different functions through the length of the Acode.

In one embodiment, the Acode system applies 5 digits short codes only; however the length of Acode can be extended to meet different requirements. Acode extended to 6 to 7 digits can be served as short term campaigns like lucky draw, TV questionnaire, and etc. Acode extended to 8 or 9 digit, can even be designed for personal blog that match the personal mobile numbers in a particular city. Acode extended to over 13 digits can be scanned to get a bar code data for retrieving product information. Since the Acode are numeric data, the extra typing skill is not required. Finally, advertising campaign like draw lot can pass encrypted identities to protect personal privacy, and enjoy a real time feedback result to attract more participants.

In another embodiment, it can be used along with other codes. A university which is an Acode member can apply an Acode “13320” and publish it to the public. A student who is an Acode client perceives the Acode “13320” can access the information of that university through the Acode website or application in the client device. Since each of the department or faculty has their own website or information to give out, the Acode “13320” may lead the Acode client to a centralized and categorized result list of all the departments and faculties. Alternatively, the university may assign another code to each department or faculty for even easier access. If the code ‘12’ is assigned to the department of social science, it can be published to its department office, signage board or road signpost. The student can quickly access the information of the social science department by entering the code “12” in the centralized and categorized result list instead of browsing and selecting it.

While the present patent application has been shown and described with particular references to a number of embodiments thereof, it should be noted that various other changes or modifications may be made without departing from the scope of the present invention.

What is claimed is:

1. An indexing and information retrieval system comprising:
a database configured for storing a record of content and indexing the record with a code;
a member device configured for inputting the record to the database with the code; and
a client device configured for retrieving the record from the database with the code; wherein:
the code is associated with a predetermined location.

2. The indexing and information retrieval system of claim 1, wherein the member device is configured to input the record with the code and information regarding a property of the predetermined location, the client device is configured to retrieve the record with the code and the information regarding the property, and the database is configured to index the record with the code and the information regarding the property.

3. The indexing and information retrieval system of claim 1, wherein the member device is configured to input the record with the code, information regarding a property of the predetermined location, and a category of the record, the client device is configured to retrieve the record with the information regarding the property of the predetermined location and the category of the record, and the database is configured to index the record with the code and the information regarding the property of the predetermined location and the category of the record.

4. The indexing and information retrieval system of claim 2, wherein the property of the predetermined location comprises an identification code.

5. The indexing and information retrieval system of claim 4, wherein the identification code is an International Direct Dialing code (IDD), a postal code, a zip code, a global location number (GLN) etc.

6. The indexing and information retrieval system of claim 1, wherein the code is associated with a plurality of locations that comprise the predetermined location, the database is configured to determine a ranking associated with the plurality of locations, and the client device is configured to retrieve the record with the code and the ranking.

7. The indexing and information retrieval system of claim 6, wherein the client device is configured to send location information of the client device to the database, and the database is configured to determine the ranking by the location information.

8. The indexing and information retrieval system of claim 7, wherein the location information is the information regarding the current location of the client device, and the database is configured to give a higher ranking to a record with location that is closer to the current location of the client device.

9. The indexing and information retrieval system of claim 7, wherein the location information is the information regarding the locations that the client device has been to recently and the database is configured to give a higher ranking to a record with location that the client device has recently been to more frequently.

10. The indexing and information retrieval system of claim 7, wherein the location information of the client device is generated through a Global Positioning System or a computer network.

11. The indexing and information retrieval system of claim 7, wherein the client device is configured to send location information of the client device to the database by sending information regarding a nearby location.

12. The indexing and information retrieval system of claim 1, wherein the member device and the client device are computers connected to a network, and the database is implemented on a server connected to the network.

13. The indexing and information retrieval system of claim 1, wherein the code is a numerical code perceived by a client through a publication or advertisement by visualization, hearing or touching, and the client device is operated by the client and configured to receive the code by the client through a keyboard, a camera, a microphone, or a scanner.

14. The indexing and information retrieval system of claim 1, wherein the record of content comprises a geographic map or is linked to a web site.

15. A method for code based indexing and information retrieval, the method comprising:
storing a record of content and indexing the record with a code by a database;
inputting the record to the database with the code by a member device; and
retrieving the record from the database with the code by a client device; wherein:
the code is associated with a predetermined location.

16. The method of claim 15, wherein the code is associated with a plurality of locations that comprise the predetermined location, the method further comprising determining a ranking associated with the plurality of locations by the database, and retrieving the record with the code and the ranking by the client device.

17. The method of claim 16 further comprising sending location information of the client device to the database by the client device, wherein the ranking is determined by the database with the location information.

18. An indexing and information retrieval system comprising:
a database configured for storing a record of content and indexing the record with a code;
a member device configured for inputting the record to the database with the code; and
a client device configured for retrieving the record from the database with the code; wherein:
the code is a numerical code associated with a predetermined location;
the member device is configured to input the record with the code and information regarding a property of the predetermined location;
the client device is configured to retrieve the record with the code and the information regarding the property; and
the database is configured to index the record with the code and the information regarding the property.

19. The indexing and information retrieval system of claim 18, wherein the code is associated with a plurality of locations that comprise the predetermined location, the client device is configured to send location information of the client device to the database and to retrieve the record with the code and a ranking associated with the plurality of locations, and the database is configured to determine the ranking by the location information.

20. The indexing and information retrieval system of claim 19, wherein the location information is the information regarding the locations that the client device has been to recently and the database is configured to give a higher ranking to a location that the client device has recently been to more frequently.

21. The indexing and information retrieval system of claim 1, wherein the location is an area that comprises a circular area having a radius about a specified geographic reference point.

22. The indexing and information retrieval system of claim 1, wherein the location is an area defined by at least three geographic reference points.

23. The indexing and information retrieval system of claim 22, wherein the area defined by at least three geographic reference points is a polygon.
